(19) United States
(12) Patent Application Publication
(10) Pub. No.: US 2008/0140879 A1
(43) Pub. Date: Jun. 12, 2008

(54) Apparatus and Methods for Controlling Memory Access Responsive to an ATA Transmission Parameter

(75) Inventors: Chang-Duck Lee, Seoul (KR); Kui-Yon Mun, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/951,453

(22) Filed: Dec. 6, 2007

(30) Foreign Application Priority Data
Dec. 6, 2006 (KR) 2006-123218

(51) Int. Cl. G06F 13/28

(52) U.S. Cl. 710/28

(57) ABSTRACT

A memory system includes a memory and a memory controller coupled to the memory and configured to be connected to an advanced technology attachment (ATA) host, the memory controller including a memory interface configured to access to the memory and configured to control an access cycle to the memory by the memory interface in accordance with date rate information for the ATA host. The data rate information may include an ATA transmission mode of the ATA host.

### CROSS-REFERENCE TO RELATED APPLICATION

This application claims priority from Korean Patent Application No. 2006-123218 filed on Dec. 6, 2006 in the Korean Intellectual Property Office, the disclosure of which is incorporated herein by reference in its entirety.

### FIELD OF THE INVENTION

The present invention disclosed herein relates to memory devices used as solid-state disks (SSDs) and, more particularly, to apparatus and methods for controlling rate of data transfer to and from such memory devices.

### BACKGROUND OF THE INVENTION

Even with the rapid increase in the processing speed of central processing units (CPU), increase in the speed at which input/output (I/O) blocks read data from storage has been relatively slower. Therefore, the speed of applications using CPUs with plenty of processing speed may be degraded due to bottlenecks at the I/O blocks.

The recent sharp drop in prices of memory products makes it common to employ secondary storage with memories, for example, a secondary storage using a memory unit, such as a NAND flash memory, sometimes referred to as a solid state disk (SSD). An SSD may be connected with a host by way of an advanced technology attachment (ATA) interface, a system bus interface for accessing a hard disk by a processor.

ATA transmission modes include a programmed I/O (PIO) mode (the oldest), a direct memory access (DMA) mode, and an ultra DMA (UDMA) mode, classified in accordance with transmission rate. Table 1 summarizes cycle times of a system clock signal and the maximum transmission rates of data in the PIO mode, while Table 2 summarizes cycle times of a system clock signal and the maximum transmission rates of data in the UDMA mode.

TABLE 1

| PIO mode | Cycle time [ns] | The maximum transmission rate [MB/s] |
|---|---|---|
| Mode 0 | 600 | 3.3 |
| Mode 1 | 383 | 5.2 |
| Mode 2 | 240 | 8.3 |
| Mode 3 | 180 | 11.1 |
| Mode 4 | 120 | 16.7 |

TABLE 2

| UDMA mode | Cycle time [ns] | The maximum transmission rate [MB/s] |
|---|---|---|
| Mode 0 | 58 | 16.7 |
| Mode 1 | 38 | 25.0 |
| Mode 2 | 29 | 33.3 |
| Mode 3 | 22 | 44.4 |
| Mode 4 | 14 | 66.7 |

The PIO mode is an interface technique for directly regulating data transmission between a system and a hard disk by means of a system CPU and assistant hardware. As the PIO mode is carried out by the system CPU, a system processor transmits commands for transferring data to a driver or receiving data from the driver through a specific I/O storage space. Generally, the greater the amount of data to be transferred, the more of the CPU processing power is used, which can slow operation speed. Therefore, the PIO mode is typically no longer employed in new systems, and has been supplanted by the DMA and UDMA modes.

The DMA mode enables a hard disk to directly communicate with a system memory by isolating the CPU therefrom. The DMA mode typically indicates a transmission protocol for transferring information from a memory by a peripheral device without a processor. In UDMA, a double transition clocking technique is applied to the DMA mode. The double transition clocking is a technique that transfers data at rising and falling edges of a clock signal. Therefore, the UDMA mode may operate at twice the data transmission rate of the DMA mode.

In order to reduce power consumption in a system using an SSD, the SSD may be controlled to reduce or minimize power consumption within the range without significant loss of performance. For example, an ATA host may be connected to an SSD in the PIO mode-2 (16.7 MHz). The SSD may be capable of operating in the UDMA mode-2 (33 MHz) at maximum. If a clock of the SSD is fixed to the maximum of 33 MHz and a control signal accessing a memory operates in sync with a system clock, the SSD may dissipate more power at the lower rate PIO mode-2 without improvement of performance, as power consumption typically is proportional to a frequency of the system clock.

### SUMMARY OF THE INVENTION

In some embodiments of the present invention, a memory system includes a memory and a memory controller coupled to the memory and configured to be connected to an advanced technology attachment (ATA) host, the memory controller including a memory interface configured to access to the memory and configured to control an access cycle to the memory by the memory interface in accordance with date rate information for the ATA host. The data rate information may include an ATA transmission mode of the ATA host.

The memory controller may include a clock controller configured to control a system clock of a system bus coupling an ATA interface of the memory controller to the memory interface in accordance with the ATA transmission mode. The clock controller may be configured to control a frequency of the system clock in inverse proportion to a clock cycle time of the ATA transmission mode and in direct proportion to a bus width of the system bus.

The access cycle may include assertion of a write enable signal and assertion of a read enable signal by the memory interface. The memory controller may be configured to control a frequency of the access cycle in inverse proportion to a cycle time of the ATA transmission mode and in direct proportion to a bus width of a bus coupling the memory interface to the memory.

In additional embodiments of the present invention, a memory controller for interfacing a memory to an ATA host includes an ATA interface configured to be coupled to the ATA host and a memory interface coupled to the ATA interface and configured to be coupled to the memory. The memory controller further includes a control circuit operatively associated with the ATA interface and the memory interface and configured to control an access cycle to the memory by the memory interface in accordance with date rate information for the ATA host.

Further embodiments of the present invention provide methods of operating a memory controller that interfaces an ATA host to a memory. A command is received from the ATA host and an ATA transmission mode is determined in response to the ATA command. An access cycle to the memory via the memory controller is controlled in accordance with the ATA transmission mode.

### BRIEF DESCRIPTION OF THE DRAWINGS

FIG. 1 is a block diagram illustrating a memory system in accordance with some embodiments of the present invention;

FIG. 2 is a flow chart showing operations of the memory system shown in FIG. 1; and

FIG. 3 is a block diagram illustrating a memory system in accordance with further embodiments of the present invention.

### DETAILED DESCRIPTION OF EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

In the drawings, the sizes or configurations of elements may be idealized or exaggerated for clarity. It will be understood that when an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third etc. may be used herein to describe various elements, components and/or sections, these elements, components and/or sections should not be limited by these terms. These terms are only used to distinguish one element, component, or section from another element, region or section. Thus, a first element, component or section discussed below could be termed a second element, component or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

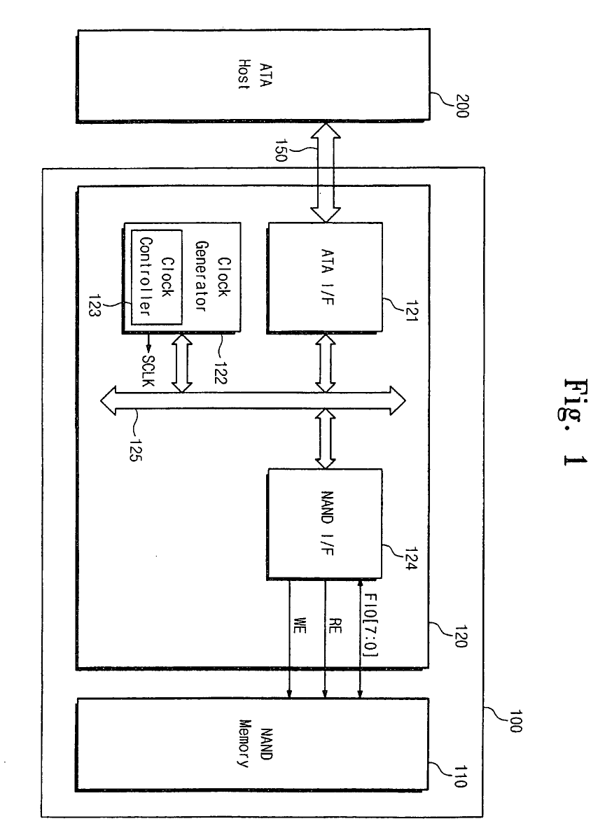

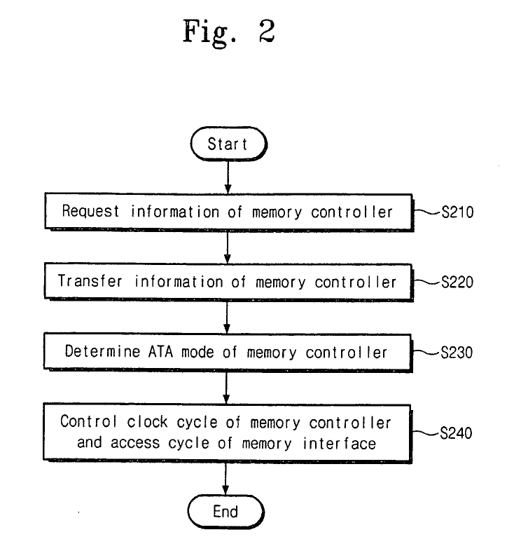

FIG. 1 is a block diagram illustrating a memory system in accordance with some embodiments of the present invention, and FIG. 2 is a flow chart showing an operation of the memory system shown in FIG. 1. Referring to FIGS. 1 and 2, the memory system 100 is connected to an ATA host 200 by way of an ATA interface (ATA I/F) 121 coupled to a bus 150. The memory system 100 includes a NAND flash memory 110 and a memory controller 120. The memory controller 120 includes the ATA interface 121, a clock generator 122, a clock controller 123, a NAND interface (NAND I/F) 124, and a system bus 125.

The ATA host 200 accesses the memory system 100 by way of the ATA interface 121. The memory controller 120 accesses the NAND memory 110 by way of the NAND interface 124. The clock generator 122 generates a system clock SCLK of the memory controller 120. The clock controller 123 controls a cycle of the system clock SCLK, which is provided from the clock generator 122, by analyzing a command of the ATA host 200, thus controls an access cycle including a read enable signal RE or a write enable signal WE applied to the NAND memory 110. In particular, the read enable signal RE controls reading of data from the NAND memory 110, and the write enable signal WE controls storing of data in the NAND memory 110.

Responding to the read enable signal RE, data stored in the NAND memory 110 is read through a data bus FIO[7:0] of the NAND interface 124. Responding to the write enable signal WE, data transferred from the ATA host 121 are stored in the NAND memory 110 by way of the data bus FIO[7:0] of the NAND interface 124.

The read enable and write enable signals RE, WE provided to memory controller 120 for accessing the NAND memory 110 through the NAND interface 124 operate responsive to the clock SCLK. Thus, the access cycles including the read enable or write enable signals RE, WE vary with cycles of the clock SCLK.

Referring to FIG. 2 in conjunction with FIG. 1, in a step S210, the ATA host 200 requests an interface to the memory controller 120, e.g., the ATA host 200 requests information regarding the maximum transmission rate from the memory system 100 through the ATA interface 121. In a step S220, the memory controller 120 transfers information about the interface to the ATA host 200, e.g., the memory system 100 transfers information of the maximum transmission rate to the ATA host 200 through the ATA interface 121.

In a step S230, the ATA host 200 determines an ATA mode of the memory controller 120. Thereafter, in a step S240, the clock controller 123 operates to control a frequency F_{sys} of the system clock SCLK in accordance with the determined ATA mode. The clock generator 122 sets the frequency F_{sys} of the system clock SCLK in response to control of the clock controller 123 as indicated in Equation 1, discussed below.

The clock controller 123 also controls the read enable and write enable signals RE, WE of the NAND interface 124 in accordance with the determined ATA mode. The NAND interface 124 generates the read enable and write enable signals RE, WE responsive to the clock controller 123.

Equation 1 is a formula for calculating the system clock frequency F_{sys} of the memory controller 123 in accordance with an ATA mode and a system bus width:

F_{sys}=1/Tcyc*Bwidth. (1)

In Equation 1, Tcyc denotes a cycle time (nanoseconds; ns) of an ATA mode. The aforementioned Table 1 shows cycle times in the PIO mode, while Table 1 shows cycle times in the UDMA mode. In Equation 1, Bwidth represents a value obtained from dividing a width (i.e., the number of bits) of the system bus 125 by 16 bits. For instance, assuming that the bus 150 coupled to the ATA interface 121 is fixed to 16 bits and the system bus 125 of the memory controller 120 is 32 bits, the value of Bwidth is set to 2. If the ATA host 200 interfaces with the memory controller 120 in the PIO mode-2, the system clock F_{sys} of the memory controller 120 is set to be 1/120 ns*2=16.7 MHz by Equation 1.

Equation 2 is a formula for calculating the access cycle frequency N_{Tcyc} of the read enable and write enable signals RE, WE in accordance with an ATA mode and a width of the data bus FIO[7:0]:

N_{Tcyc}=1/Tcyc*Fwidth. (2)

In Equation 2, Fwidth denotes a width of the bus FIO[7:0] of the NAND interface 124. Some embodiments of the present invention use 8 bits of the NAND interface bus FIO[7:0], for which the value of Fwidth is 2, i.e., the value of Fwidth is 2 when the NAND interface bus width is 8 bits, while Fwidth is 1 for 16 bits. For example, if the memory bus FIO[7:0] is 8 bits and the ATA host 200 interfaces with the memory controller 120 in the PIO mode-2, the access cycle of the read enable and write enable signals RE, WE of the NAND interface 124 is 1/120 ns*2=16.7 MHz. In other words, if the system bus of the memory controller 120 is 32 bits and the memory bus is 8 bits in width and the ATA host 200 operates in the PIO mode-2 at 16.7 MHz, the system clock of the memory controller and the access cycle of the read enable and write enable signals RE, WE may operate at 16.7 MHz in order to reduce power consumption of the memory controller without degradation of performance. Therefore, some embodiments of the present invention are able to generate the clock of the memory controller in consideration of an internal system bus width and control the access rate of the signals controlling a memory in consideration of the ATA mode and a width of the data bus accessing the memory, which may be helpful for reducing power consumption of the memory controller without undue performance degradation.

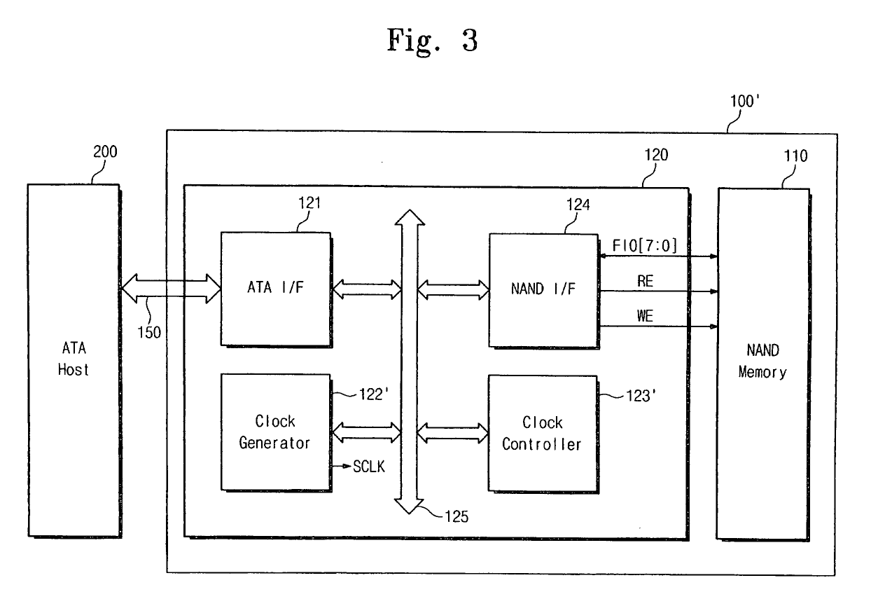

FIG. 3 is a block diagram illustrating a memory system 100′ in accordance with further embodiments of the present invention. Like components in FIGS. 1 and 3 are indicated by like reference signs and description thereof will be omitted in light of the foregoing description of FIG. 1. The memory system 100′ differs from the memory system 100 of FIG. I in that a clock controller 123′ is separate from a clock generator 122′. The clock controller 123′ operates to control the clock generator 122′ and a NAND interface 124′ through the system bus 125.

As described above, some embodiments of the present invention may be effective in reducing power consumption of a memory controller in a memory system by controlling a clock cycle of the memory controller and an access cycle of a control signal for a memory.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims.

What is claimed is:

1. A memory system comprising:
a memory; and
a memory controller coupled to the memory and configured to be connected to an advanced technology attachment (ATA) host, the memory controller comprising a memory interface configured to access to the memory and configured to control an access cycle to the memory by the memory interface in accordance with date rate information for the ATA host.

2. The memory system of claim 1, wherein the data rate information comprises an ATA transmission mode of the ATA host.

3. The memory system of claim 2, wherein the memory controller comprises a clock controller configured to control a system clock of a bus coupling an ATA interface of the memory controller the memory interface in accordance with the ATA transmission mode.

4. The memory system of claim 3, wherein the clock controller is configured to control a frequency of the system clock in inverse proportion to a clock cycle time of the ATA transmission mode and in direct proportion to a bus width of the system bus.

5. The memory system of claim 2, wherein the access cycle comprises assertion of a write enable signal or a read enable signal by the memory interface.

6. The memory system of claim 5, wherein the memory controller is configured to control a frequency of the access cycle in inverse proportion to a cycle time of the ATA transmission mode and in direct proportion to a bus width of a bus coupling the memory interface to the memory.

7. The memory system of claim 5, wherein when the write enable signal is activated, data transferred from the ATA host is stored in the memory.

8. The memory system of claim 5, wherein when the read enable signal is activated, data stored in the memory is read.

9. The memory system of claim 2, wherein the ATA transmission mode includes a programmed input/output mode, a direct memory access mode, and an ultra direct memory access mode.

10. The memory system of claim 1, wherein the memory comprises a NAND flash memory.

11. A memory controller for interfacing a memory to an ATA host, the memory controller comprising:
an ATA interface configured to be coupled to the ATA host;
a memory interface coupled to the ATA interface and configured to be coupled to the memory; and
a control circuit operatively associated with the ATA interface and the memory interface and configured to control an access cycle to the memory by the memory interface in accordance with date rate information for the ATA host.

12. The memory controller of claim 1, wherein the data rate information comprises an ATA transmission mode of the ATA host.

13. The memory controller of claim 12, further comprising a system bus coupling the ATA interface to the memory interface and wherein the control circuit comprises a clock controller configured to control a system clock of the system bus in accordance with the ATA transmission mode.

14. The memory controller of claim 13, wherein the clock controller is configured to control a frequency of the system clock in inverse proportion to a clock cycle time of the ATA transmission mode and in direct proportion to a bus width of the system bus.

15. The memory controller of claim 12, wherein the access cycle comprises assertion of a write enable signal or a read enable signal by the memory interface.

16. The memory controller of claim 15, wherein the control circuit is configured to control a frequency of the access cycle in inverse proportion to a cycle time of the ATA transmission mode and in direct proportion to a bus width of a bus coupling the memory interface to the memory.

17. A method of operating a memory controller that interfaces an ATA host to a memory, the method comprising:
receiving an a command from the ATA host;
determining an ATA transmission mode in response to the ATA command; and
controlling an access cycle to the memory via the memory controller in accordance with the ATA transmission mode.

18. The method of claim 17, wherein the memory controller includes a memory interface configured to access the memory and wherein controlling an access cycle to the memory via the memory controller in accordance with the ATA transmission mode comprises varying the access cycle to the memory by the memory interface in inverse proportion to a clock cycle time of the ATA transmission mode and in direct proportion to a bus width of a bus coupling the memory interface to the memory.

19. The method of claim 17, wherein the memory controller includes an ATA interface that couples the memory controller to the ATA host and a memory interface that couples the ATA interface to the memory and wherein controlling an access cycle to the memory via the memory controller in accordance with the ATA transmission mode comprises varying a frequency of a system clock of a system bus connecting the ATA interface to the memory interface in inverse proportion to a clock cycle of the ATA transmission mode and in direct proportion to a bus width of the system bus.
